(19) United States
(12) Patent Application Publication
(10) Pub. No.: US 2026/0009681 A1
(43) Pub. Date: Jan. 8, 2026

(54) BOLOMETER, INFRARED DETECTION DEVICE, AND INFRARED DETECTION METHOD

(71) Applicant: NEC Corporation, Tokyo (JP)

(72) Inventor: Akinobu SHIBUYA, Tokyo (JP)

(73) Assignee: NEC Corporation, Tokyo (JP)

(21) Appl. No.: 19/233,049

(22) Filed: Jun. 10, 2025

(30) Foreign Application Priority Data
Jul. 2, 2024 (JP) 2024-106596

(51) Int. Cl. G01J 5/22

(52) U.S. Cl. CPC G01J 5/22

(57) ABSTRACT

A bolometer includes a gate electrode to which a gate voltage is capable of being applied, a drain electrode to which a drain voltage is capable of being applied, a source electrode, and a first film connecting the drain electrode and the source electrode and including carbon nanotubes. The gate voltage is swept with a periodicity between an upper limit value and a lower limit value.

This application is based upon and claims the benefit of priority from Japanese Patent Application No. 2024-106596, filed on Jul. 2, 2024, the disclosure of which is incorporated herein in its entirety by reference.

### TECHNICAL FIELD

The present disclosure relates to a bolometer, an infrared detection device, and an infrared detection method.

### BACKGROUND ART

It is known to use a bolometer as an infrared sensor.

For example, JP 2015-49207 A discloses a bolometer in which a temperature coefficient of resistance (TCR) related to improvement of an infrared sensor is enhanced using semiconducting carbon nanotubes (CNTs).

### SUMMARY

A bolometer of the present disclosure including:
a gate electrode to which a gate voltage is capable of being applied;
a drain electrode to which a drain voltage is capable of being applied;
a source electrode; and
a first film connecting the drain electrode and the source electrode and including carbon nanotubes, in which
the gate voltage is swept with a periodicity between an upper limit value and a lower limit value.

An infrared detection method of the present disclosure including:
with respect to a bolometer including a gate electrode, a drain electrode, a source electrode, and a first film connecting the drain electrode and the source electrode, the first film including carbon nanotubes,
applying a drain voltage to the drain electrode; and
sweeping a gate voltage, with respect to the gate electrode, with a periodicity between an upper limit value and a lower limit value.

### BRIEF DESCRIPTION OF THE DRAWINGS

FIG. 1 is a diagram illustrating an example of a configuration of an infrared detection device according to the present disclosure;

FIG. 2 is a cross-sectional view I illustrating an example of a configuration of a bolometer according to the present disclosure;

FIG. 3 is a diagram illustrating an example of transport properties of a bolometer according to the present disclosure;

FIG. 4 is a diagram illustrating an example of electrical properties calculated based on the transport properties of the bolometer according to the present disclosure;

FIG. 5 is a diagram illustrating an example of a relationship between the electrical properties of the bolometer according to the present disclosure and a drain voltage applied to a drain electrode;

FIG. 6 is a diagram I illustrating an example of a relationship between the electrical properties of the bolometer according to the present disclosure and a periodicity of a gate voltage applied to a gate electrode;

FIG. 7 is a diagram illustrating an example of a waveform of each voltage value when the bolometer according to the present disclosure is swept;

FIG. 8 is a diagram II illustrating an example of a relationship between the electrical properties of the bolometer according to the present disclosure and a periodicity of the gate voltage applied to the gate electrode;

FIG. 9 is a flowchart I illustrating an example of processing of an infrared detection method according to the present disclosure;

FIG. 10 is a diagram illustrating an example of a waveform of each voltage value when a bolometer according to a modification is swept;

FIG. 11 is a cross-sectional view illustrating an example of a configuration of the bolometer according to the modification;

FIG. 12 is a cross-sectional view II illustrating an example of a configuration of the bolometer according to the present disclosure; and

FIG. 13 is a flowchart II illustrating an example of processing of the infrared detection method according to the present disclosure.

### EXAMPLE EMBODIMENT

Hereinafter, examples of example embodiments according to the present disclosure will be described with reference to the drawings. The drawings and specific configurations employed in the example embodiments are not intended to be used for the interpretation of the disclosure. In all the drawings, the same or corresponding components are denoted by the same reference numerals, and the common description will not be repeated.

In the present disclosure, the drawings are associated with one or more example embodiments.

### First Example Embodiment

Hereinafter, an example embodiment according to the present disclosure will be described with reference to the drawings.

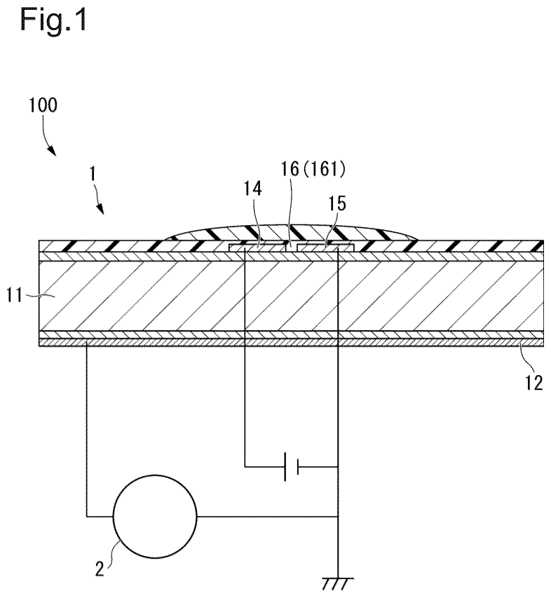

Hereinafter, an example of a configuration of a bolometer in the present disclosure will be described with reference to FIGS. 1 to 8.

### (Configuration of Infrared Detection Device)

An infrared detection device 100 is used to measure a drain current at a predetermined detection timing and detect infrared rays.

As illustrated in FIG. 1, the infrared detection device 100 includes a bolometer 1 and a sweep unit 2.

The sweep unit 2 periodically sweeps a gate voltage with respect to a gate voltage applied to a gate electrode included in the bolometer 1. The sweep unit 2 may be a sweep signal generator or another signal generator. The sweep unit 2 may be a multivibrator or another oscillator circuit.

Examples of the gate voltage having a periodicity include a pulse wave, a saw-tooth wave, and a triangular wave.

### (Configuration of Bolometer)

The bolometer 1 is used as a sensor for detecting infrared rays.

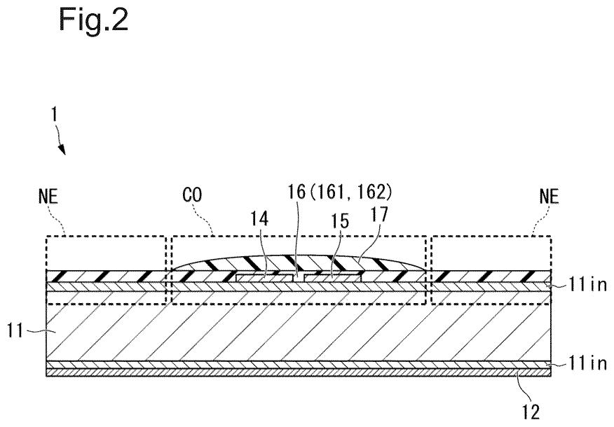

As illustrated in FIG. 2, the bolometer 1 includes a substrate 11, a gate electrode 12, a drain electrode 14, a source electrode 15, a first film 16, and a second film 17.

### (Configuration of Substrate)

The substrate 11 is a Si substrate processed using a silicon wafer.

For example, a readout circuit may be formed on the substrate 11.

For example, a micro electro mechanical system (MEMS) structure in which the lower portion of the bolometer is hollow may be formed on the substrate 11 in order to sufficiently secure a temperature rise amount accompanying infrared absorption.

For example, a polymer film such as Parylene (registered trademark) having a low thermal conductivity may be formed on the substrate 11 in order to ensure thermal insulating properties.

For example, the substrate 11 may have an underlying insulating layer for electrical insulation. As a method for forming the underlying insulating layer, existing methods include a method for subjecting the substrate 11 to heat treatment, a method for directly forming the underlying insulating layer by a chemical vapor deposition (CVD) method, a method for applying a solution in which a polymer or a polymer precursor is dissolved by spin coating and heat treatment to form a polymer film, and the like. Examples of the underlying insulating layer include silicon oxide, silicon nitride, polyimide, and Parylene (registered trademark).

The drain electrode 14 and the source electrode 15 are formed on a first surface of the substrate 11. The gate electrode 12 is formed on a second surface of the substrate 11. For example, the gate electrode 12 is formed over the entire region of the second surface. The first film 16 is laminated in such a way as to cover the drain electrode 14 and the source electrode 15. For example, patterning of the drain electrode 14 and the source electrode 15 with respect to the substrate 11 is performed by a lift-off method using photolithography.

### (Gate Electrode)

The gate electrode 12 is provided on the second surface of the substrate 11.

A gate voltage can be applied to the gate electrode 12.

The gate voltage includes a voltage applied to the gate electrode 12 with respect to the source electrode 15. The gate voltage in the present disclosure is swept with a periodicity between the upper limit value and the lower limit value.

### (Drain Electrode)

The drain electrode 14 is provided on the first surface of the substrate 11.

A drain voltage can be applied to the drain electrode 14.

The drain voltage includes a voltage applied to the drain electrode 14 with respect to the source electrode 15.

For example, a negative voltage may be applied to the drain electrode 14.

For example, the drain electrode 14 includes an electrode formed by using Au, Al, Ti, or an alloy mainly including Au, Al, and Ti. As an example, the drain electrode 14 may have a laminated structure in which an Au layer is laminated on a layer including an alloy such as Ti.

### (Source Electrode)

The source electrode 15 is provided on the first surface of the substrate 11.

For example, the source electrode 15 is connected to a ground (GND).

For example, the source electrode 15 includes an electrode formed by using Au, Al, Ti, or an alloy mainly including Au, Al, and Ti. As an example, the source electrode 15 may have a laminated structure in which an Au layer is laminated on a layer including an alloy such as Ti.

### (First Film)

The first film 16 includes an infrared ray receiving unit.

The first film 16 connects the drain electrode 14 and the source electrode 15.

For example, the first film 16 covers the drain electrode 14 and the source electrode 15.

The following two examples will be described as examples of the first film 16.

### (Example of First Film)

The first film 16 includes a plurality of CNTs 161.

For example, in the present disclosure, the first film 16 has a CNT network formed by a plurality of CNTs 161.

In each of the CNTs 161 included in the first film 16, carriers in each of the CNTs 161 are induced by application of a gate voltage. As a result, a drain current flows between the drain electrode 14 and the source electrode 15.

The induced carriers in each of the CNTs 161 change according to doping via the second film 17 described later.

### (Carbon Nano Tube (CNT))

The CNTs 161 include fibrous materials, each having a diameter of 0.6 to 1.5 nm and a length of 100 nm to 5.0 μm. The properties of the CNTs 161 change depending on the arrangement of six-membered rings in the circumferential direction.

Regarding the CNTs 161, a cylindrical CNT formed by one sheet of graphene is called a single-walled CNT, and a CNT formed by a plurality of CNTs having different diameters and coaxially overlapping each other to form a plurality of layers is called a multi-walled CNT. A double-layered CNT is called a double-walled CNT.

For example, the CNTs 161 may include any one of a single-walled CNT, a double-walled CNT, or a multi-walled CNT.

As an example, the CNTs 161 of the present disclosure include a single-walled CNT.

The CNTs 161 have a semiconductor type exhibiting semiconducting properties and a metal type exhibiting metallic properties. The single-walled CNTs usually includes semiconducting CNTs and metallic CNTs in a ratio of 2:1. Therefore, in a case where CNTs exhibiting one property are used in a large amount, a separation step is required.

For example, the CNTs 161 may include semiconducting CNTs. As a result, the absolute value of TCR in the bolometer 1 can be improved.

### (Another Example of First Film)

In a case where the first film 16 includes a plurality of CNTs 161, the first film may further include oxide particles 162. In this case, a silane coupling agent may be further included. In a case where the silane coupling agents are modified in the oxide particles 162, the adhesion of the carbon nanotubes 161 to the oxide particles 162 is improved. For example, the silane coupling agent is 3-aminopropyltriethoxysilane (APTES).

In the present disclosure, for example, the first film 16 includes the oxide particles 162.

For example, the oxide particles 162 may have a particulate form.

The particle size of the oxide particle 162 may be about the same as the length of the carbon nanotube 161. For example, as the particle size of the oxide particle 162 is larger, it is easier for a carbon nanotube 161 having a longer length to form a three-dimensional structure. For example, as the particle size of the oxide particle 162 is smaller, it is easier for a carbon nanotube 161 having a shorter length to form a three-dimensional structure. In a case where a network structure formed by the plurality of CNTs 161 more easily forms a three-dimensional network structure, a conductive path of each CNT 161 increases, and it is easier for the first film 16 to obtain a low resistance value. As the resistance value of the first film 16 decreases, the resistance of the bolometer 1 is likely to decrease.

### (Oxide Particles)

Examples of the oxide particle 162 include oxides including one or two or more elements of Li, Al, Fe, Ni, Co, Mn, Bi, La, Cu, Sn, Zn, V, Zr, Pb, Sm, Y, W, Si, P, Ru, Ti, Ge, Ca, Ga, Cr, Cd, Mg, and Er, but are not limited thereto. For example, the oxide particle 162 may include two or more kinds of oxides.

For example, the oxide particle 162 includes Zn₂₋ₓTₓP₂O₇ (where, T includes at least one element selected from Mg, Al, Si, Ti, V, Cr, Mn, Fe, Co, Ni, Cu, Ga, Ge, Zr, Nb, Mo, Ag, In, Sn, Sb, La, Ta, W, and Bi, and satisfies 0<x<2), and the oxide defined by the above-described formula is pyrophosphate.

For example, the oxide particle 162 includes Zn_{2-z}Mg_{z}P₂O₇ (0≤z≤2) (hereinafter, referred to as ZMPO). ZMPO is included in pyrophosphate.

For example, the oxide particle 162 includes Zn_{2-z}Mg_{z}P₂O₇ (z=0.4).

Other examples of the oxide particle 162 include BNFO, ZnO, and Er₂O₃.

BNFO is BiNi_{1-y}Fe_{y}O₃. (0<y<1)

For example, the oxide particle 162 exhibits insulating properties. In the present disclosure, for example, the oxide particle 162 includes ZMPO and exhibits insulating properties.

In a case where the first film 16 has the oxide particles 162, the thickness of the first film 16 is appropriately set. For example, the thickness of the first film 16 having the oxide particles 162 is 2 μm to 6 μm.

In the present disclosure, for example, the first film 16 includes the CNTs 161 and the oxide particles 162. In a part of the first film 16, the plurality of carbon nanotubes 161 are dispersed in such a way as to form a network on the surfaces of the oxide particles 162, within a film formed by assembling the oxide particles 162. Therefore, the first film 16 has a network structure formed by the plurality of carbon nanotubes entangled. This network has a three-dimensional network structure.

Assuming that a region where the second film 17 is formed is a region CO, in a region (region NE) adjacent to the region CO, the carbon nanotubes 161 may be removed by oxygen plasma treatment, and the proportion of a porous film described later may be increased.

### (Second Film)

The second film 17 is selectively provided on a surface of the first film 16.

The second film 17 includes a polymer material, and performs doping on the first film 16.

The second film 17 functions to dope the CNTs 161 included in the first film 16 by donating electrons (carriers induced by the gate voltage are electrons: N-type doping) or extracting electrons (carriers induced by the gate voltage are holes: P-type doping). The doping may cause the minimum value of the TCR curve to shift near a gate voltage of 0 V.

CNTs are naturally electrically neutral. However, for example, in an air environment, the CNTs 161 may be P-doped with water or oxygen. Therefore, since the first film 16 including the CNTs 161 is doped, the measured value of the drain current is easily stabilized. As a result, the TCR curve is less likely to fluctuate greatly each time when the drain current is measured. The N-type doping may be used to cancel the P-type doping by oxygen or water adsorbed to the CNTs 161.

For example, the second film 17 may include poly methyl methacrylate (PMMA), poly(4-vinylpyridine) (P4VP), or poly(4-vinylpyridine-co-bytyl methacrylate) (P4VBM). For example, a PMMA film formed using a PMMA solution in which anisole is dissolved serves to dope the CNTs 161 included in the first film 16.

Alternatively, the second film 17 may include an insulating film including silicon oxide, alumina, or the like.

In the present disclosure, the second film 17 includes PMMA.

In the following description, the first film 16 exhibits the similar tendency regardless of the presence or absence of the oxide particles 162. Therefore, the first film 16 is sufficient to include at least the CNTs 161.

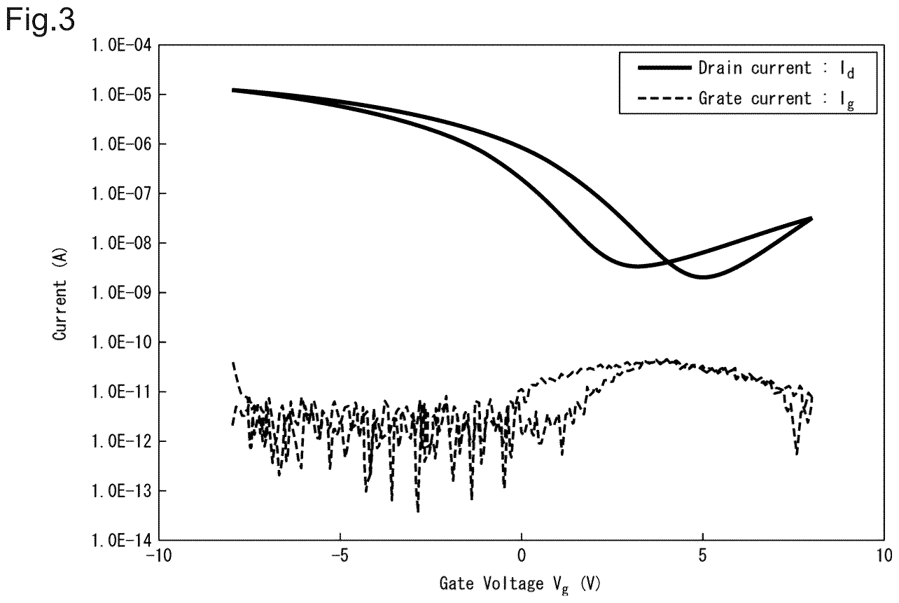

In FIG. 3, the transport properties of the bolometer 1 having the CNT network in which the CNTs 161 are P-type doped in the first film 16 are illustrated.

In FIG. 3, in a case where the gate voltage is swept between −8 V and 8 V and then swept toward −8 V with respect to the bolometer 1, a drain current (I_{d}) value measured at each gate voltage (V_{g}) value is indicated as the transport properties. FIG. 3 illustrates the transport properties in a state where a drain voltage (V_{d}) (V_{d}=−3.0 V) is applied to the bolometer 1 under an environment of 298 K. As a supplement, FIG. 3 also illustrates a gate current (I_{g}) value measured at each gate voltage value.

In a case where the temperature in the ambient environment of a test element increases from 293 K to 303 K while other conditions are maintained, the drain current I_{d} value increases.

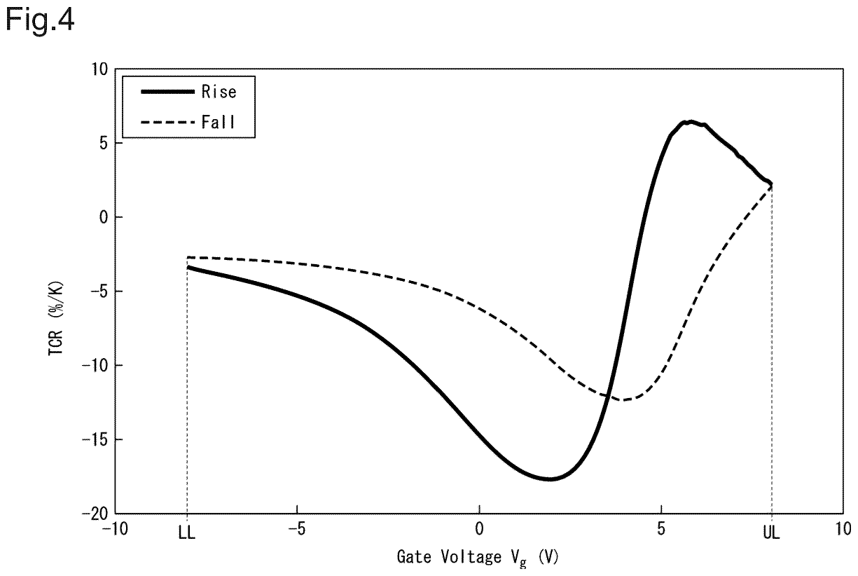

FIG. 4 is a curve (TCR curve) illustrating TCR values calculated based on the transport properties at 293 K and the transport properties at 303 K for each gate voltage value. In the present disclosure, the negative TCR is illustrated because semiconducting carbon nanotubes are used.

In FIG. 4, a rising path of the gate voltage from a lower limit value LL (V_{g}=−8.0 V) to an upper limit value UL (V_{g}=8.0 V) is represented by a path Rise. A falling path of the gate voltage from the upper limit value UL (V_{g}=8.0 V) to the lower limit value LL (V_{g}=−8.0 V) is represented by a path Fall. In this case, hysteresis of the TCR is observed.

In the path Rise, TCR=−18%/K, where the TCR reaches its maximum absolute value, can be observed at the gate voltage V_{g}=2.0 V. In the path Fall, TCR=−12%/K, where the TCR reaches its maximum absolute value, can be observed at the gate voltage V_{g}=4.0 V. In the path Fall, TCR=−10%/K can be observed even at the gate voltage V_{g}=2.0 V.

In FIG. 4, the first film 16 includes the oxide particles 162. An absolute value of each TCR when the oxide particles 162 are included takes a value larger than an absolute value of each TCR when the oxide particles 162 are not included.

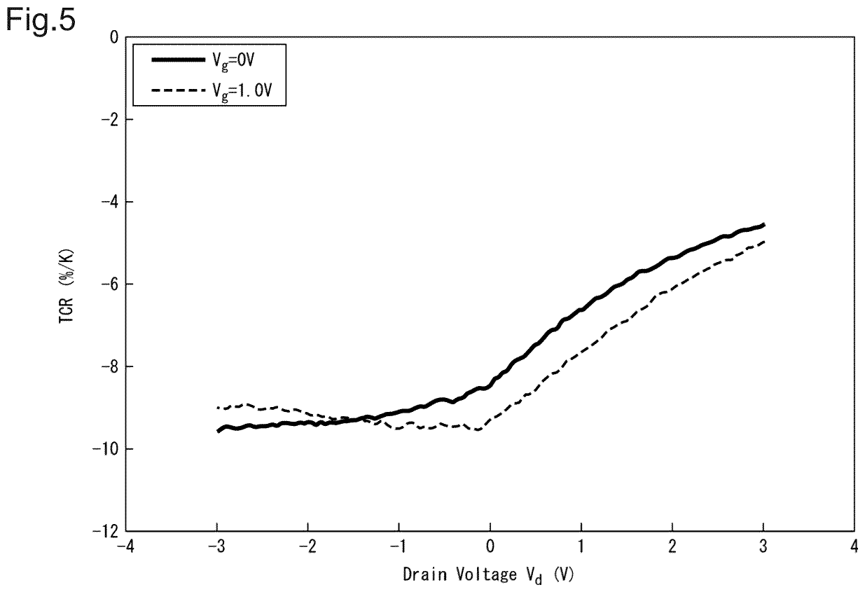

In the description of FIG. 5, for the bolometer 1, a relationship between the drain current I_{d} and the drain voltage V_{d} at 293 K and a relationship between the drain current I_{d} and the drain voltage V_{d} at 303 K with respect to the gate voltages (V_{g}=0 V and 1.0 V) were acquired.

FIG. 5 illustrates data calculated based on the acquired data. FIG. 5 illustrates the dependency of the TCR on the drain voltage V_{d}. From this result, it can be seen that the absolute value of the TCR is less than 10 (TCR>−10%/K) at both gate voltages V_{g}.

Therefore, it is construed that the absolute value of the TCR is likely to be a large value by sweeping the gate voltage V_{g} in a state where a predetermined drain voltage V_{d} is applied rather than sweeping the drain voltage V_{d} in a state where a predetermined gate voltage V_{g} is applied.

As described above, the bolometer 1 of the present disclosure is intended for measuring the drain current I_{d} at the timing when the absolute value of the TCR increases due to the hysteresis of the TCR during the sweep.

In a case where there is a value X of the gate voltage V_{g}, at which the absolute value of the TCR reaches the maximum value in the path Rise or the path Fall of the gate voltage V_{g}, the measurement of the drain current I_{d} may be performed at the timing when the value X is obtained.

As described below, in the bolometer 1, the drain current I_{d} is measured in synchronization with a certain period.

### (Upper Limit Value and Lower Limit Value of Gate Voltage)

As described above, a gate voltage V_{g} in the present disclosure is swept with a periodicity between the upper limit value and the lower limit value. The following example in which the value X of the gate voltage V_{g}, at which the absolute value of the TCR reaches the maximum value, is set to the upper limit value or the lower limit value of the gate voltage V_{g} will be described.

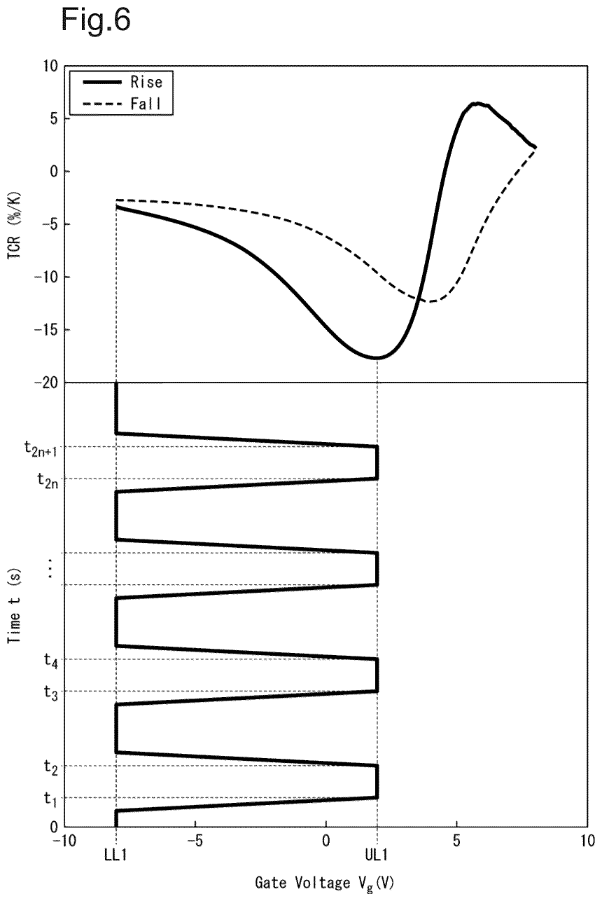

In FIG. 6, for example, in a case where the drain voltage is negative (V_{d}=−3 V) in the bolometer 1, the gate voltage V_{g} is swept with a periodicity between an upper limit value UL1 and a lower limit value LL1. In this case, the upper limit value UL1 is a gate voltage V_{g} at which the gradient in the TCR curve is 0, and the lower limit value LL1 is a gate voltage V_{g} at which the gradient is a negative value.

It is assumed that the gate voltage V_{g} is swept from the lower limit value LL1 to the upper limit value UL1. In this case, the measurement of the drain current I_{d} may be performed at the timing when the gate voltage reaches the upper limit value UL1 (t=t₁, t₃ . . . , and t₂ₙ₊₁).

The measurement of the drain current I_{d} may be performed at a timing (t=t₂, t₄ . . . , and t₂ₙ) when the gate voltage V_{g} starts to be swept from the upper limit value UL1 to the lower limit value LL1.

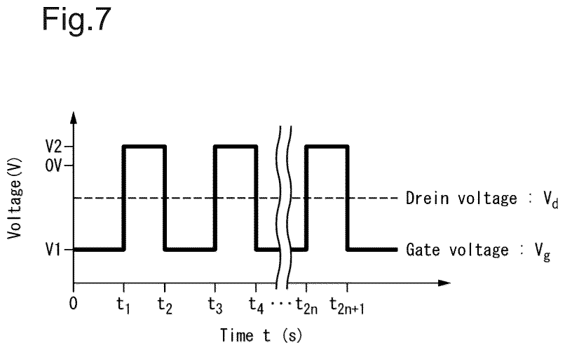

As illustrated in FIG. 7, the waveform of the gate voltage V_{g} is not limited to the waveform illustrated in FIG. 6. Examples of the gate voltage V_{g} having a periodicity include a pulse wave, a saw-tooth wave, and a triangular wave.

The gate voltage V_{g} at the timing of detecting the drain current I_{d} may be positive, negative, or 0 V, and it is sufficient to use the gate voltage V_{g} at which the TCR caused by the first film 16 reaches its maximum.

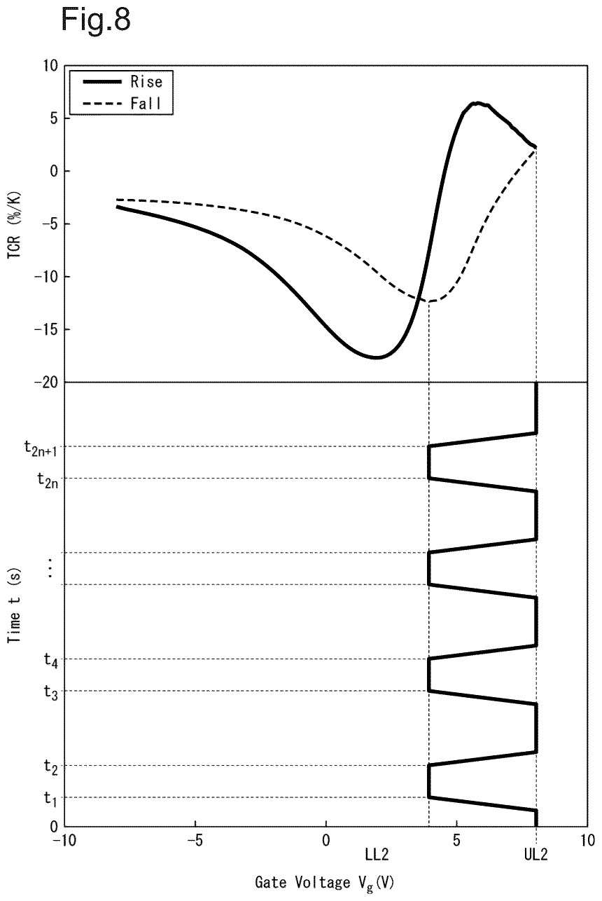

In FIG. 8, for example, in a case where the drain voltage V_{d} is negative (V_{d}=−3.0 V) in the bolometer 1, the gate voltage is swept with a periodicity between an upper limit value UL2 and a lower limit value LL2. In this case, the lower limit value LL2 is a gate voltage when the gradient in the TCR curve is 0.

It is assumed that the gate voltage V_{g} is swept from the upper limit value UL2 to the lower limit value LL2. In this case, the measurement of the drain current I_{d} may be performed at the timing when the gate voltage reaches the lower limit value LL2 (t=t₁, t₃ . . . , and t₂ₙ₊₁).

The measurement of the drain current I_{d} may be performed at a timing (t=t₂, t₄ . . . , and t₂ₙ) when the gate voltage V_{g} starts to be swept from the lower limit value LL2 to the upper limit value UL2.

### (Infrared Detection Method)

An infrared detection method in the present example embodiment will be described.

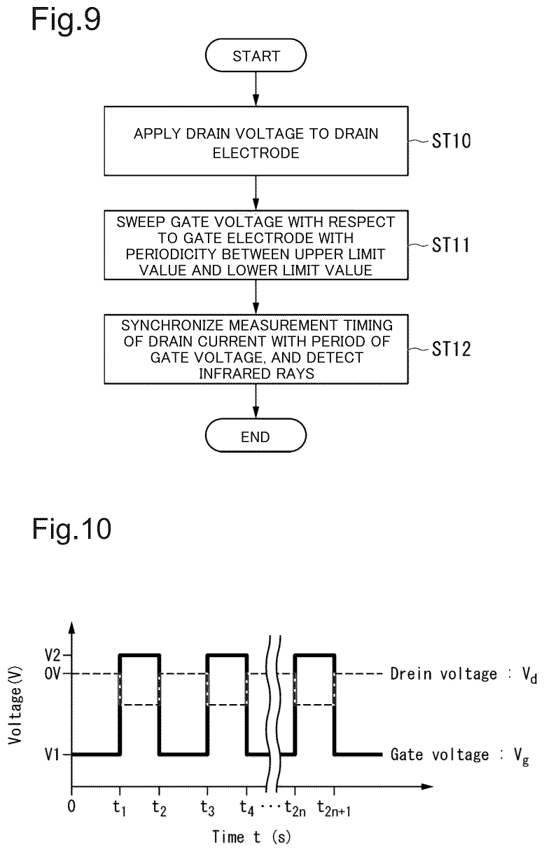

The infrared detection method in the present example embodiment is performed according to a flow illustrated in FIG. 9.

First, an operator applies a drain voltage V_{d} to the drain electrode 14 (step ST10: a step of applying a drain voltage).

Specifically, the operator applies a drain voltage V_{d} to the bolometer including the gate electrode 12, the drain electrode 14, the source electrode 15, and the first film 16 connecting the drain electrode 14 and the source electrode 15 and including carbon nanotubes.

Next, the operator sweeps the gate voltage V_{g} with respect to the gate electrode 12 with a periodicity between the upper limit value and the lower limit value (step ST11: a step of sweeping a gate voltage).

Specifically, the operator sweeps the gate voltage with a periodicity using the sweep unit 2.

For example, the operator may acquire the relationship between the gate voltage V_{g} and the TCR in advance by preliminary measurement, and then determine the upper limit value and the lower limit value. In the first film 16 including the CNTs 161, the hysteresis of the TCR is observed regardless of the presence or absence of the oxide particles 162. That is, in a case where the gate voltage is swept from the upper limit value to the lower limit value or the gate voltage is swept from the lower limit value to the upper limit value, the absolute value of the TCR can reach the maximum value at any timing. The operator determines the upper limit value and the lower limit value of the gate voltage V_{g} in such a way that the measurement of the drain current I_{d} is performed at the timing when the absolute value of the TCR increases from the lower limit value or the upper limit value, or the timing when the absolute value of the TCR reaches the maximum value.

Next, the operator synchronizes the measurement timing of the drain current I_{d} with the period of the gate voltage, and detects infrared rays with the bolometer 1 (step ST12).

Here, at a specific timing in the period of the gate voltage V_{g} swept in ST12, infrared rays are detected in such a way that the absolute value of the TCR can be maximized (completed).

### Operation and Effect

According to the bolometer 1 of the present disclosure, since sweeping the gate voltage V_{g} is performed with the periodicity between the upper limit value and the lower limit value, the measurement of the drain current I_{d} can be performed at the timing when the absolute value of the TCR increases from the lower limit value or the upper limit value, or at the timing when the absolute value of the TCR reaches the maximum value.

Accordingly, the bolometer of the present disclosure is favorable for achieving the high TCR.

As a comparative example, a bolometer in which a CNT network is used as a bolometer resistance element is exemplified. In such a bolometer resistance element, there is a concern whether TCR is stably obtained because of hysteresis of the drain current I_{d}. In a case where the CNTs 161 and the oxide particles 162 are included in the bolometer resistance element, the TCR can have a large value, and the hysteresis of the drain current I_{d} can be increased.

In this case, according to the bolometer 1 of the present disclosure, since sweeping the gate voltage V_{g} is performed with the periodicity between the upper limit value and the lower limit value, the measurement of the drain current I_{d} can be performed at the timing when the absolute value of the TCR increases from the lower limit value or the upper limit value, or at the timing when the absolute value of the TCR reaches the maximum value.

Therefore, the bolometer 1 of the present disclosure is likely to stably obtain the TCR having a predetermined value.

The bolometer of the present disclosure can include “the gate electrode 12 to which a gate voltage V_{g} is capable of being applied, the drain electrode 4 to which a drain voltage V_{d} is capable of being applied, the source electrode 15, and the first film 16 connecting the drain electrode 14 and the source electrode 15 and including carbon nanotubes 161, in which the gate voltage V_{g} is swept with a periodicity between the upper limit value and the lower limit value”, thereby obtaining the following effects.

The bolometer of the present disclosure can obtain the effect as follows: “since sweeping the gate voltage V_{g} is performed with the periodicity between the upper limit value and the lower limit value, the measurement of the drain current I_{d} can be performed at the timing when the absolute value of the TCR increases from the lower limit value or the upper limit value, or at the timing when the absolute value of the TCR reaches the maximum value”. Therefore, the bolometer 1 of the present disclosure is favorable for achieving the high TCR.

Furthermore, in the bolometer of the present disclosure, since “the upper limit value or the lower limit value is the gate voltage V_{g} when the gradient of the temperature coefficient of resistance is 0”, the measurement of the drain current I_{d} can be performed at the timing when the absolute value of the TCR reaches the maximum value. As a result, it is also possible to obtain an effect that “it is easy to stably obtain the TCR reaching its maximum absolute value”.

Furthermore, in the bolometer of the present disclosure, since “the lower limit value is the gate voltage V_{g} having a negative value”, in a case where the gate voltage V_{g} is swept from the lower limit value to the upper limit value to have a negative value, the absolute value of the TCR is likely to be maximum as compared with the case where the gate voltage V_{g} is swept from the upper limit value to the lower limit value to have a negative value.

Furthermore, in the bolometer of the present disclosure, since “the first film 16 includes the oxide particles 162”, the CNTs 161 included in the first film 16 can be attached in such a way as to be leaned against the surfaces of the oxide particles 162, and the CNTs 161 can be easily arranged three-dimensionally. The number of conductive paths involving each CNT 161 in the network structure increases. Therefore, the first film 16 serving as a resistance element unit of the bolometer 1 can easily obtain a low resistance value. Therefore, in the bolometer of the present disclosure, a low resistance value is easily obtained.

Furthermore, in the bolometer of the present disclosure, since “the oxide particle 162 includes at least pyrophosphate”, the TCR can have a large value, and the first film 16 can easily obtain a low resistance value.

Furthermore, in the bolometer of the present disclosure, since “the first film 16 includes the silane coupling agent”, the adhesion of the carbon nanotubes 161 to the oxide particles 162 is improved.

Furthermore, in the bolometer of the present disclosure, since “the second film 17 provided on the surface of the first film 16 and performing doping on the first film 16” is included, the following effects can be obtained.

In the bolometer of the present disclosure, since the first film 16 including the CNTs 161 is doped, the measured value of the drain current I_{d} is easily stabilized. As a result, the TCR curve is less likely to fluctuate greatly each time when the drain current I_{d} is measured.

Furthermore, in the bolometer of the present disclosure, since “the second film 17 includes the polymer material”, the following effects can be obtained.

In the bolometer of the present disclosure, since the first film 16 including the CNTs 161 is doped, the measured value of the drain current I_{d} is easily stabilized. As a result, the TCR curve is less likely to fluctuate greatly each time when the drain current I_{d} is measured.

Furthermore, in the bolometer of the present disclosure, since “the second film includes PMMA, P4VP, or P4VBM”, the following effects can be obtained.

In the bolometer of the present disclosure, since the first film 16 including the CNTs 161 is doped, the measured value of the drain current I_{d} is easily stabilized. As a result, the TCR curve is less likely to fluctuate greatly each time when the drain current I_{d} is measured.

Furthermore, in the bolometer of the present disclosure, since “the carbon nanotubes (CNTs 161) are semiconducting carbon nanotubes”, it is also possible to obtain the effect of “the absolute value of the TCR of the bolometer 1 can be improved”.

### Modification

### (Part 1)

As illustrated in FIG. 10, a drain voltage V_{d} may have a pulse waveform. The drain voltage V_{d} applied to the bolometer 1 of the present disclosure may be positive or negative. However, again, as illustrated in FIG. 5, since the minimum value of the TCR is observed in a case where the drain current I_{d} is negative, the drain voltage V_{d} having a negative value may be applied to the bolometer 1.

The drain voltage V_{d} is necessary to be applied to the drain electrode 14 to such an extent that the drain current I_{d} can be detected.

### (Part 2)

The bolometer 1 may have a configuration similar to a bolometer 1B.

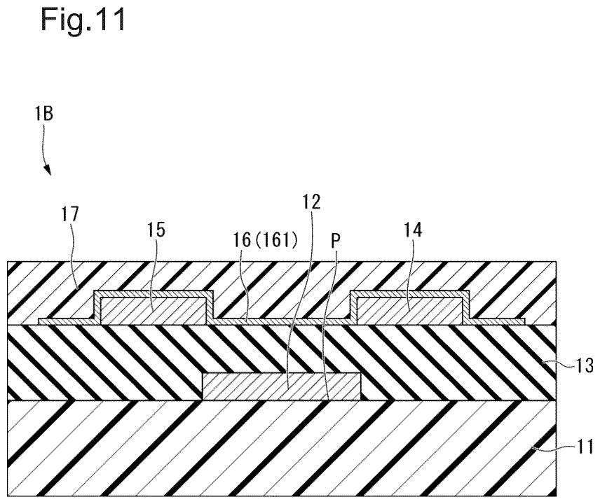

As illustrated in FIG. 11, the bolometer 1B includes the substrate 11, the gate electrode 12, an insulating film 13, the drain electrode 14, the source electrode 15, the first film 16, and the second film 17.

The bolometer 1B is different from the bolometer 1 in that the insulating film 13 is provided and the gate electrode 12 is provided on the drain electrode 14 (source electrode 15) side as viewed from the substrate 11. The gate electrode 12 is provided on a part P of the surface of the substrate 11.

Components common to those in the above-described disclosure are denoted by the same reference numerals, and detailed description thereof will not be repeated.

### (Insulating Film)

The insulating film 13 is provided on a part of the surface of the substrate 11 with the gate electrode 12 interposed therebetween. The insulating film 13 may substantially dope the first film 16.

The insulating film 13 is laminated in such a way as to cover the surface of the substrate 11 and the surface of the gate electrode 12. Since the first film 16 covers the drain electrode 14 and the source electrode 15, the contact area between the CNTs 161 in the CNT network and the drain electrode 14 or the source electrode 15 increases, and the resistance of the bolometer 1 can be reduced.

For example, the insulating film 13 may have a thickness enough to protect the first film 16 from P-type doping with water or oxygen.

### Second Example Embodiment

Hereinafter, an example embodiment according to the present disclosure will be described with reference to the drawings.

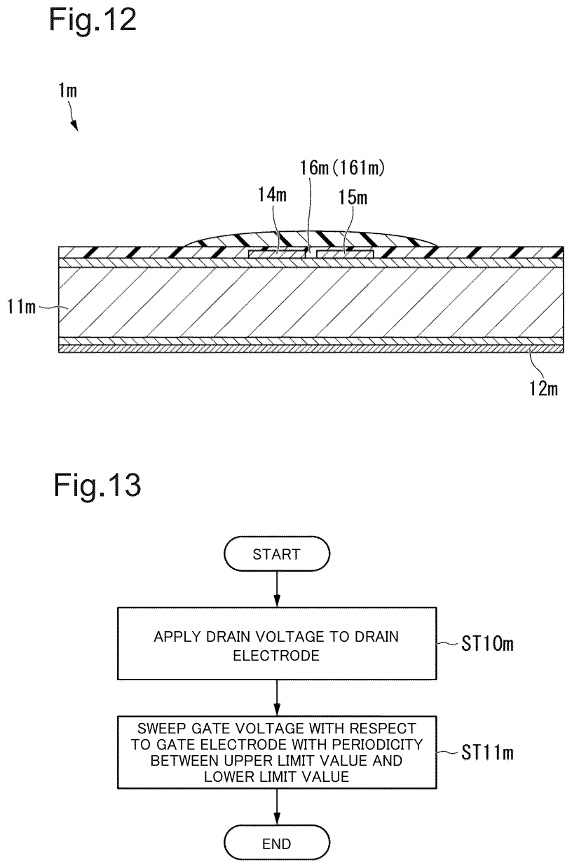

Hereinafter, an example of a configuration of a bolometer in the present disclosure will be described with reference to FIG. 12.

### Configuration

A bolometer 1m includes a gate electrode 12m to which a gate voltage is capable of being applied, a drain electrode 14m to which a drain voltage is capable of being applied, a source electrode 15m, and a first film 16m connecting the drain electrode 14m and the source electrode 15m and including carbon nanotubes 161m, and the gate voltage is swept with a periodicity between an upper limit value and a lower limit value.

### Operation and Effect

According to the bolometer 1m of the present disclosure, since sweeping the gate voltage is performed with the periodicity between the upper limit value and the lower limit value, the measurement of the drain current I_{d} can be performed at the timing when the absolute value of the TCR increases from the lower limit value or the upper limit value, or at the timing when the absolute value of the TCR reaches the maximum value.

Accordingly, the bolometer of the present disclosure is favorable for achieving the high TCR.

### Third Example Embodiment

Hereinafter, an example embodiment according to the present disclosure will be described with reference to the drawings.

Hereinafter, an example of the infrared detection method in the present disclosure will be described with reference to FIG. 13.

The infrared detection method in the present disclosure is performed according to a flow illustrated in FIG. 13.

The infrared detection method includes, with respect to a bolometer including a gate electrode, a drain electrode, a source electrode, and a first film connecting the drain electrode and the source electrode and including carbon nanotubes, a step of applying a drain voltage to the drain electrode (step ST10m: a step of applying a drain voltage), and a step of sweeping a gate voltage with respect to the gate electrode, with a periodicity between an upper limit value and a lower limit value (step ST11m: a step of sweeping a gate voltage).

### Operation and Effect

According to the infrared detection method of the present disclosure, since sweeping the gate voltage is performed with the periodicity between the upper limit value and the lower limit value, the measurement of the drain current I_{d} can be performed at the timing when the absolute value of the TCR increases from the lower limit value or the upper limit value, or at the timing when the absolute value of the TCR reaches the maximum value.

Accordingly, the infrared detection method of the present disclosure is favorable for achieving the high TCR.

While the present disclosure has been particularly shown and described above with reference to example embodiments thereof, the present disclosure is not limited to these example embodiments. It will be understood by those of ordinary skill in the art that various changes in form and details may be made therein without departing from the spirit and scope of the present disclosure as defined by the claims. Each example embodiment can be appropriately combined with another example embodiment.

### Another Modification

### (Infrared Absorbing Layer)

In order to improve the infrared ray absorption amount, an infrared absorbing layer may be provided in the bolometer 1 of the above-described disclosure. The infrared absorbing layer is provided on a surface of the second film 17.

As a material used for the infrared absorbing layer, gold black, a carbon material such as carbon nanotubes, carbon nanohorns, or carbon black, a composite material including these carbon materials and a polymer resin, or the like can be used. In a case where the composite material is used, polyvinyl alcohol (PVA), PMMA, P4VP, or the like can be employed as the polymer resin, but the polymer resin is not limited to these three kinds as long as CNTs can be uniformly dispersed and the structure of the polymer resin can be maintained.

An infrared light-receiving element disclosed in Patent Literature 1 includes a channel unit that is doped with a control member including an electrolyte to control a position of the Fermi level in the channel unit including CNTs. In addition, it is disclosed that the infrared light-receiving element can further control the position of the Fermi level in the channel unit including CNTs by setting a voltage between a source electrode and a drain electrode and a voltage between the source electrode and a gate electrode, resulting in enabling the control of TCR values.

However, depending on the voltage values to be set, it may be difficult to achieve a high TCR.

One of an object of the present disclosure is to provide a bolometer, an infrared detection device, and an infrared detection method for solving the above-described problem.

According to the bolometer, the infrared detection device, and the infrared detection method according to the present disclosure, it is favorable for achieving the high TCR.

Some or all of the above-described example embodiments may be described as the following supplementary notes, but are not limited to the following supplementary notes.

### Supplementary Note 1

A bolometer including:
a gate electrode to which a gate voltage is capable of being applied;
a drain electrode to which a drain voltage is capable of being applied;
a source electrode; and
a first film connecting the drain electrode and the source electrode and including carbon nanotubes, in which
the gate voltage is swept with a periodicity between an upper limit value and a lower limit value.

### Supplementary Note 2

The bolometer according to Supplementary Note 1, in which
the upper limit value or the lower limit value is a gate voltage in the case of a gradient of a temperature coefficient of resistance being 0.

### Supplementary Note 3

The bolometer according to Supplementary Note 1 or 2, in which
the lower limit value is a gate voltage having a negative value.

### Supplementary Note 4

The bolometer according to any one of Supplementary Notes 1 to 3, in which
the first film includes oxide particles.

### Supplementary Note 5

The bolometer according to Supplementary Note 4, in which
each of the oxide particles include at least pyrophosphate.

### Supplementary Note 6

The bolometer according to Supplementary Note 4 or 5, in which
the first film includes a silane coupling agent.

### Supplementary Note 7

The bolometer according to any one of Supplementary Notes 1 to 6, further including
a second film provided on a surface of the first film and performing doping on the first film.

### Supplementary Note 8

The bolometer according to Supplementary Note 7, in which
the second film includes a polymer material.

### Supplementary Note 9

The bolometer according to Supplementary Note 7 or 8, in which
the second film includes PMMA, P4VP, or P4VBM.

### Supplementary Note 10

The bolometer according to any one of Supplementary Notes 1 to 9, in which
the drain voltage has a negative value.

### Supplementary Note 11

The bolometer according to any one of Supplementary Notes 1 to 10, in which
the carbon nanotubes include semiconducting carbon nanotubes.

### Supplementary Note 12

An infrared detection device including:
a bolometer according to any one of Supplementary Notes 1 to 11; and
a sweep unit sweeping the gate voltage.

### Supplementary Note 13

An infrared detection method including:
with respect to a bolometer including a gate electrode, a drain electrode, a source electrode, and a first film connecting the drain electrode and the source electrode and including carbon nanotubes,
applying a drain voltage to the drain electrode; and
sweeping a gate voltage with respect to the gate electrode, with a periodicity between an upper limit value and a lower limit value.

1. A bolometer comprising:
a gate electrode to which a gate voltage is capable of being applied;
a drain electrode to which a drain voltage is capable of being applied;
a source electrode; and
a first film connecting the drain electrode and the source electrode and including carbon nanotubes, wherein
the gate voltage is swept with a periodicity between an upper limit value and a lower limit value.

2. The bolometer according to claim 1, wherein
the upper limit value or the lower limit value is a gate voltage in the case of a gradient of a temperature coefficient of resistance being 0.

3. The bolometer according to claim 2, wherein
the lower limit value is a gate voltage having a negative value.

4. The bolometer according to claim 1, wherein
the first film includes oxide particles.

5. The bolometer according to claim 4, wherein
the first film includes a silane coupling agent.

6. The bolometer according to claim 4, further comprising
a second film provided on a surface of the first film and performing doping on the first film.

7. The bolometer according to claim 1, wherein
the drain voltage has a negative value.

8. The bolometer according to claim 1, wherein
the carbon nanotubes include semiconducting carbon nanotubes.

9. The bolometer according to claim 4, wherein
each of the oxide particles include at least pyrophosphate.

10. The bolometer according to claim 6, wherein
the second film includes a polymer material.

11. The bolometer according to claim 6, wherein
the second film includes PMMA, P4VP, or P4VBM.

12. An infrared detection device comprising:
a bolometer including a gate electrode to which a gate voltage is capable of being applied, a drain electrode to which a drain voltage is capable of being applied, a source electrode, and a first film connecting the drain electrode and the source electrode and including carbon nanotubes; and
a sweep unit sweeping the gate voltage, wherein
the gate voltage is swept with a periodicity between an upper limit value and a lower limit value.

13. An infrared detection method comprising:
with respect to a bolometer including a gate electrode, a drain electrode, a source electrode and a first film connecting the drain electrode and the source electrode, the first film including carbon nanotubes,
applying a drain voltage to the drain electrode; and
sweeping a gate voltage, with respect to the gate electrode, with a periodicity between an upper limit value and a lower limit value.
